(19) United States
(12) Patent Application Publication
(10) Pub. No.: US 2025/0224290 A1
(43) Pub. Date: Jul. 10, 2025

(54) Method for Measuring Residual Stress in Thin Plate

(71) Applicants: Chinalco Materials Application Research Institution Co., Ltd., Beijing (CN); Chinalco Advanced Manufacturing Co., Ltd., Chongqing (CN)

(72) Inventors: Junqiang WANG, Beijing (CN); Hailong CAO, Beijing (CN); Cheng LIU, Beijing (CN); Guojun WANG, Beijing (CN); Dongnan HUANG, Beijing (CN); Wei LI, Beijing (CN); Fuguan CONG, Beijing (CN); Xueguang DONG, Beijing (CN); Siping ZHANG, Beijing (CN); Haiyun LUO, Beijing (CN); Mingdong HUANG, Beijing (CN); Kai LI, Beijing (CN); Yibin REN, Beijing (CN); Xiaoyu SONG, Beijing (CN); Qing LI, Beijing (CN)

(21) Appl. No.: 18/574,084

(22) PCT Filed: Jul. 4, 2023
(86) PCT No.: PCT/CN2023/105773

§ 371 Date: Dec. 26, 2023

(30) Foreign Application Priority Data
Sep. 30, 2022 (CN) 202211212028.2

(51) Int. Cl. G01L 5/00

(52) U.S. Cl. CPC G01L 5/0047

(57) ABSTRACT

Provided is a method for measuring residual stress in a thin plate. The method includes: S1: prearranging and cutting a plurality of fins, computing x-direction strain εᵢ₀ and x-direction residual stress σᵢ₀ in the length direction of the thin plate borne by each fin, and obtaining distribution of x-direction residual stress in the width direction of the thin plate according to all σᵢ₀; S2: repeatedly cutting the fixed ends in a thickness direction of the thin plate, computing a total cutting depth Zᵢⱼ and x-direction residual stress σᵢⱼ of each fin after each cutting, and obtaining distribution of x-direction residual stress in the thickness direction of the thin plate borne by an ith fin according to all σᵢⱼ; and S3: computing distribution σₓ, σₓ=σᵢ₀+σᵢⱼ, of x-direction residual stress on a yz cross section of the thin plate according to σᵢ₀ obtained in S1 and corresponding σᵢⱼ in S2.

### CROSS-REFERENCE TO RELATED APPLICATION(S)

The present disclosure claims priority to patent application No. 202211212028.2, filed to the China National Intellectual Property Administration on Sep. 30, 2022 and entitled “Method for Measuring Residual Stress in Thin Plate”.

### TECHNICAL FIELD

The disclosure relates to the technical field of measuring of residual stress in thin plates, and particularly to a method for measuring residual stress in a thin plate.

### BACKGROUND

High-performance thin plates are extensively applied to the fields of aerospace, electrical and electronic engineering, chip package, etc., for example, aircraft skin, chip lead frame processing, transformers and so on. In processes of processing and manufacturing the aircraft skin and chip lead frames by the thin plates, a removed surface area accounts for 80% of a total area, and a removed thickness accounts for 60% or above of a total thickness. The thin plates have low bending stiffness on account of thinness, and will largely deform even under low residual stress during a removal process. The premise of deformation control of the thin plate during the removal process is quantitative characterization of residual stress distribution of the thin plate in a thickness.

In a related art, internal residual stress of the thin plate is generally evaluated through a single-side corrosion method. In this method, one side of the thin plate is required to be protected by pasting a film, the other side of the thin plate is required to be corroded by a corrosive liquid, and after a corrosion depth reaches 50% of the thickness of the thin plate, a warpage deformation quantity is compared. This method can only qualitatively determine magnitude of the residual stress according to a deformation degree, but cannot quantitatively characterize a distribution rule of the residual stress in the thickness of thin plate.

Since the thin plate is not uniformly cooled during solution quenching, residual stress on a surface and at a center of the thin plate have different tensile and compressive states. Therefore, it is difficult to quickly guide optimization of thin plate manufacturing technique according to a deformation law obtained through the single-side corrosion method. With mass supply requirements of civil airliners and high-performance chip packaging materials, a breakthrough on quantitative characterization technique for residual stress of a thin plate is urgently required. Therefore, a method capable of rapidly and quantitatively characterizing residual stress distribution in a thin plate is required to effectively control processing deformation of the thin plate.

### SUMMARY

Some embodiments of the disclosure provide a method for measuring residual stress in a thin plate, which is used for quantitatively characterizing a distribution rule of the residual stress on a thickness of the thin plate.

In order to realize the above objective, some embodiments of the disclosure provide a method for measuring residual stress in a thin plate. The method includes: S1: prearranging and cutting a plurality of fins that are parallel to a length direction of the thin plate at equal intervals along a width direction of the thin plate, where a length of each fin is the same as each other and less than a width of the thin plate, and the fins have fixed ends and movable ends that are opposite each other, computing x-direction strain εᵢ₀ and x-direction residual stress σᵢ₀ in the length direction of the thin plate borne by each fin according to lengths of each fin before and after cutting, and obtaining distribution of x-direction residual stress in the width direction of the thin plate according to σᵢ₀ of all the fins; S2: repeatedly cutting the fixed end of the each fin in a thickness direction of the thin plate, recording a cutting parameter, and a warpage condition and a bending parameter of the each fin after each cutting, computing a total cutting depth Zᵢⱼ and x-direction residual stress σᵢⱼ of the each fin after each cutting, and obtaining distribution of x-direction residual stress in the thickness direction of the thin plate borne by an ith fin according to all σᵢⱼ; and S3: computing distribution σₓ, σₓ=σᵢ₀+σᵢⱼ, of x-direction residual stress on a yz cross section of the thin plate according to σᵢ₀ of the ith fin computed in S1 and corresponding σᵢⱼ of the ith fin after jth cutting in S2.

In some embodiments, S1 includes: S1.1: arranging cutting marks at equal intervals in the width direction of the thin plate, where an extension direction of each cutting mark is the same as each other and parallel to the length direction of the thin plate and extends to an end of the thin plate, an extension length of each cutting mark is less than a length of the thin plate, and a region between any two cutting marks forms one fin, and recording an initial length L₀ of the ith fin before cutting; and S1.2: cutting the cutting marks through the thin plate in the thickness direction of the thin plate, and recording a deformation length Lᵢ₀ of the each fin after deformation in the length direction of the thin plate.

In some embodiments, S1 further includes: S1.3: computing the x-direction strain εᵢ₀ and the x-direction residual stress σᵢ₀, εᵢ₀=(L₀−Lᵢ₀)/L₀ and σᵢ₀=Eεᵢ₀, in the length direction of the thin plate borne by each fin according to the recorded initial length L₀ of the fin and the deformation length Lᵢ₀ of the fin, where E is an elastic modulus of the thin plate.

In some embodiments, S2 includes: constraining two ends of the thin plate in the length direction before each cutting, so as to make an extension direction of each fin parallel to the width direction of the thin plate, and releasing the thin plate on one side of the movable end of the fin after each cutting, so as to compute and record the bending parameter of the ith fin after jth cutting.

In some embodiments, the total cutting depth Zᵢⱼ and the x-direction residual stress σᵢⱼ of each fin after each cutting are expressed as:

$$S > {Z}_{ij} = j Δ z ; {L}_{ij} = {L}_{i 0} - t$$

$$and {σ}_{ij} = \frac{E π}{90 m \cdot Δ z \cdot [ S - ( j - 1 ) ] Δ z} ( {I}_{ij} arcsin \frac{{h}_{ij}^{′}}{{L}_{ij}} - {I}_{i ( j - 1 )} arcsin \frac{{h}_{i ( j - 1 )}^{′}}{{L}_{ij}} ) ;$$

where Δz is a cutting depth of each cutting, t is a cutting width, Iᵢⱼ is inertia moment of an uncut portion of the ith fin after jth cutting, E is a Young's elastic modulus of the thin plate, hᵢⱼ′ is a warpage quantity of the ith fin after jth cutting minus a warpage quantity of a cut portion, hᵢⱼ is a bending height of the ith fin after jth cutting, Lᵢⱼ is a remaining length of the ith fin after jth cutting, S is a thickness of the thin plate, m is an equivalent arc length of residual stress release of the ith fin after jth cutting, and under the condition that t is infinitely close to 0, a computational formula for σᵢⱼ is expressed as:

$${σ}_{ii} = \frac{E π}{90 m \cdot Δ z \cdot [ S - ( j - 1 ) ] Δ z} ( {I}_{ij} arcsin \frac{{h}_{ij}}{{L}_{ij}} - {I}_{i ( j - 1 )} arcsin \frac{{h}_{i ( j - 1 )}}{{L}_{i ( j - 1 )}} ) .$$

In some embodiments, m is approximately expressed as: m=t+0.75S; after jth cutting of the ith fin, a notch is formed, and the ith fin is bent to form a first bent surface and a second bent surface that are spaced apart from each other in the thickness direction of the thin plate; on an xz cross section of the thin plate, the first bent surface and the second bent surface are two arcs that have the same curvature but different arc lengths, the equivalent arc length m is a length of an arc formed between two ends of an opening of the notch on the cross section, and curvature of the equivalent arc length m is the same as curvature of the two arcs; and hᵢⱼ′ is a height between a warping end of the opening of the notch on the cross section and a top end of the fin after warping, and hᵢⱼ is a height between a non-warping end of the opening of the notch on the cross section and the top end of the fin after warping.

In some embodiments, σᵢⱼ is obtained according to formulas as follows

$$d ( \sum {M}_{ij} ) = {σ}_{𝔦j} \cdot Δz \cdot m \frac{[ S - ( j - 1 ) Δ z ]}{2} ;$$

$$and d ( \sum {M}_{ij} ) = \frac{E π}{180} ( {I}_{ij} arcsin \frac{{h}_{ij}^{′}}{{L}_{ij}} - {I}_{i ( j - 1 )} arcsin \frac{{h}_{i ( j - 1 )}^{′}}{{L}_{ij}} ) ;$$

where ΣMᵢⱼ is total bending moment of the ith fin after jth cutting, and d(ΣMᵢⱼ) is a bending moment increment of the ith fin after jth cutting.

In some embodiments, a computational method for ΣMᵢⱼ is as follows: ΣMᵢⱼ=ωᵢⱼMᵢⱼ; where ωᵢⱼ is an average arc length, and Mᵢⱼ is average bending moment of the residual stress of the ith fin after jth cutting on an arc length of any unit; and after jth cutting, the i-th fin is bent to form a first bent surface and a second bent surface that are spaced apart from each other in the thickness direction of the thin plate, on an xz cross section of the thin plate, the first bent surface and the second bent surface are two arcs that have the same curvature but different arc lengths, the average arc length is between the two arcs, curvature of the average arc length is the same as curvature of the two arcs, and distances between the average arc length and the arcs on two sides are the same.

In some embodiments, a computational method for Mᵢⱼ is as follows:

$${M}_{ij} = \frac{E {I}_{ij} π}{180 {ω}_{ij}} arcsin \frac{{h}_{ij}^{′}}{{L}_{ij}} .$$

In some embodiments, computational methods for ωᵢⱼ, θᵢⱼ and Iᵢⱼ are as follows:

$${θ}_{ij} = \frac{{ω}_{ij}}{{ρ}_{ij}} \cdot \frac{180}{π} ; {θ}_{ij} = arcsin \frac{{h}_{ij}^{′}}{{L}_{ij}} and \frac{1}{{ρ}_{ij}} = \frac{{M}_{ij}}{{EI}_{ij}} ;$$

where ρᵢⱼ is a curvature radius of the ith fin after jth cutting, and θᵢⱼ is a bending angle of the ith fin after jth cutting.

In some embodiments, S2 further includes: correcting the residual stress;

$$Δ ( {σ}_{ij} ) = \frac{{σ}_{ij} \cdot Δ z}{S - j Δ z} ;$$

$$and {σ}_{ij}^{′} = {σ}_{ij} - {\sum }_{1}^{j - 1} Δ {σ}_{ij} ;$$

where Δ(σᵢⱼ) is an effect of residual stress of layer Δz on residual stress of the uncut portion, and σᵢⱼ′ is a residual stress correction value of the ith fin during jth cutting.

A technical solution of the disclosure provides a method for measuring residual stress in a thin plate. The method includes: S1: prearranging and cutting a plurality of fins that are parallel to a length direction of the thin plate at equal intervals in a width direction of the thin plate, where a length of each fin is the same as each other and less than a width of the thin plate, and the fins have fixed ends and movable ends that are opposite each other, computing x-direction strain εᵢ₀ and x-direction residual stress σᵢ₀ in the length direction of the thin plate borne by each fin according to lengths of each fin before and after cutting, and obtaining distribution of x-direction residual stress in the width direction of the thin plate according to σᵢ₀ of all the fins; S2: repeatedly cutting the fixed ends of the fins in a thickness direction of the thin plate, recording a cutting parameter, and a warpage condition and a bending parameter of each fin after each cutting, computing a total cutting depth Zᵢⱼ and x-direction residual stress σᵢⱼ of each fin after each cutting, and obtaining distribution of x-direction residual stress in the thickness direction of the thin plate borne by an ith fin according to all σᵢⱼ; and S3: computing distribution σₓ, σₓ=σᵢ₀+σᵢⱼ, of x-direction residual stress on a yz cross section of the thin plate according to σᵢ₀ of the ith fin computed in S1 and corresponding σᵢⱼ of the ith fin after jth cutting in S2. According to this solution, according to distribution of a plurality of x-direction residual stress in the width direction (y direction) and the thickness direction (z direction) of the thin plate, distribution of the residual stress in the thin plate on the yz cross section is obtained, and the situation that a method for evaluating residual stress in a thin plate through a single-side corrosion method in the prior art can only qualitatively determine the residual stress, but cannot quantitatively characterize distribution of the residual stress in a thickness of the thin plate is avoided. Through computation of the solution, the residual stress and the distribution thereof in the thin plate are obtained, and characterization is accurate and reliable.

### BRIEF DESCRIPTION OF THE DRAWINGS

The accompanying drawings of the description constitute part of the disclosure and serve to provide further understanding of the disclosure, and illustrative examples of the disclosure and the description of the illustrative examples serve to explain the disclosure and are not to be construed as unduly limiting the disclosure. In the accompanying drawings:

FIG. 1 shows a flow diagram of a method for measuring residual stress in a thin plate according to an example of the disclosure;

FIG. 2 shows a schematic structural diagram of a thin plate suitable for the method in FIG. 1;

FIG. 3 shows a schematic structural diagram of a thin plate after step S1.1;

FIG. 4 shows a schematic structural diagram of a thin plate after step S1.2;

FIG. 5 shows a schematic diagram of constraint a thin plate in step S2;

FIG. 6 shows a schematic diagram of cutting a thin plate in step S2;

FIG. 7 shows a schematic diagram of bending a thin plate in step S2; and

FIG. 8 shows a schematic diagram of an xz section of a thin plate in step S2.

The above figures include reference numerals as follows:
11. notch; 12. first bent surface; and 13. second bent surface.

### DETAILED DESCRIPTION OF THE EMBODIMENTS

Technical solutions in examples of the disclosure will be clearly and completely described below in combination with accompanying drawings in the examples of the disclosure. Apparently, the examples described are merely some examples rather than all examples of the disclosure. The following description of at least one illustrative example is merely illustrative in nature and in no way serves as any limitation of the disclosure and its application or use. On the basis of examples of the disclosure, all other examples obtained by those of ordinary skill in the art without making creative efforts all fall within the scope of protection of the disclosure.

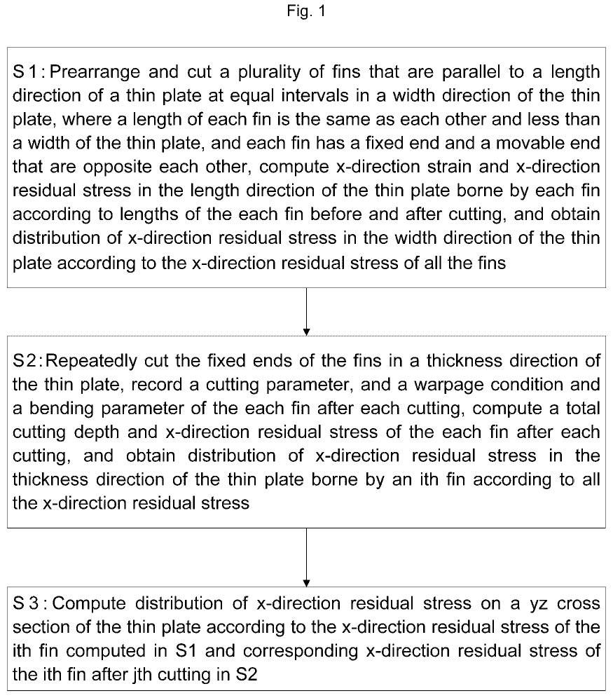

As shown in FIG. 1, an embodiment of the disclosure provides a method for measuring residual stress in a thin plate. The method includes: S1: prearrange and cut a plurality of fins that are parallel to a length direction of the thin plate at equal intervals along a width direction of the thin plate, where a length of each fin is the same as each other and less than a width of the thin plate, and the fins have fixed ends and movable ends that are opposite each other, compute x-direction strain εᵢ₀ and x-direction residual stress σᵢ₀ in the length direction of the thin plate borne by each fin according to lengths of each fin before and after cutting, and obtain distribution of x-direction residual stress in the width direction of the thin plate according to σᵢ₀ of all the fins; S2: repeatedly cut the fixed ends of the fins in a thickness direction of the thin plate, record a cutting parameter, and a warpage condition and a bending parameter of the each fin after each cutting, compute a total cutting depth Zᵢⱼ and an x-direction residual stress σᵢⱼ of the each fin after each cutting, and obtain distribution of x-direction residual stress in the thickness direction of the thin plate borne by an ith fin according to all σᵢⱼ; and S3: compute distribution σₓ=, σₓ=σᵢ₀+σᵢⱼ, of x-direction residual stress on a yz cross section of the thin plate according to σᵢ₀ of the ith fin computed in S1 and corresponding σᵢⱼ of the ith fin after jth cutting in S2.

In the embodiment, according to distribution of the plurality of x-direction residual stress in the width direction (y direction) and the thickness direction (z direction) of the thin plate, distribution of the residual stress in the thin plate on the yz cross section is obtained, and the situation that a method for evaluating residual stress in a thin plate through a single-side corrosion method in the prior art can only qualitatively determine magnitude of the residual stress, but cannot quantitatively characterize distribution of the residual stress in a thickness of the thin plate is avoided. Through computation of the solution, the residual stress magnitude and the distribution thereof in the thin plate are obtained, and characterization is accurate and reliable.

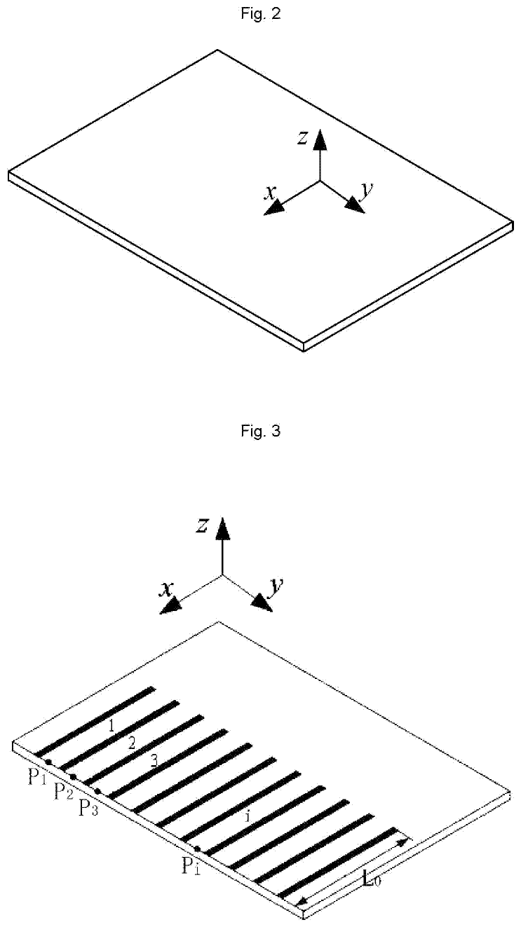

As shown in FIGS. 2-4 and 8, S1 includes: S1.1: arrange cutting marks at equal intervals in the width direction of the thin plate, where an extension direction of each cutting mark is the same as each other and parallel to the length direction of the thin plate and extends to an end of the thin plate, an extension length of the each cutting mark is less than a length of the thin plate, and a region between any two cutting marks forms one fin, and record an initial length L₀ of the ith fin before cutting; and S1.2: cut the cutting marks through the thin plate in the thickness direction of the thin plate, and record a deformation length Lᵢ₀ of the each fin after deformation in the length direction of the thin plate.

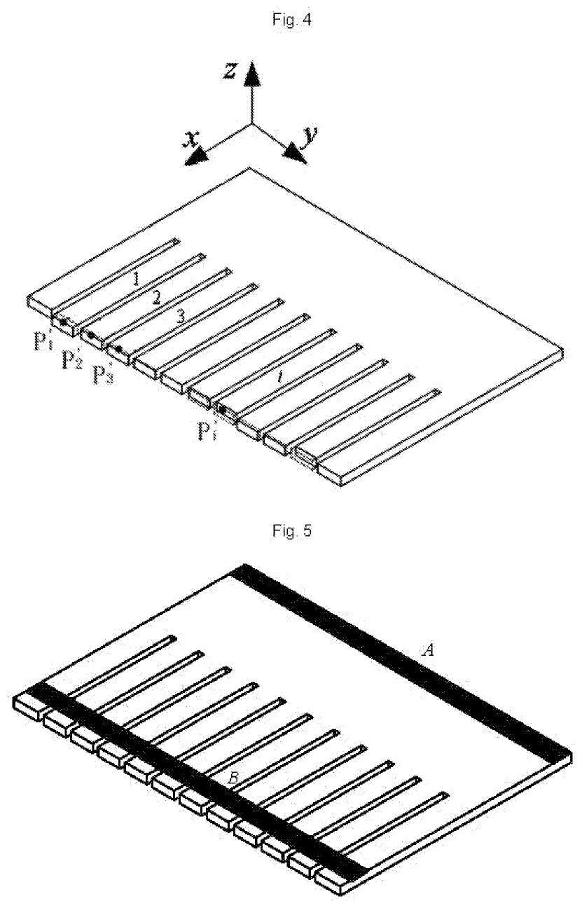

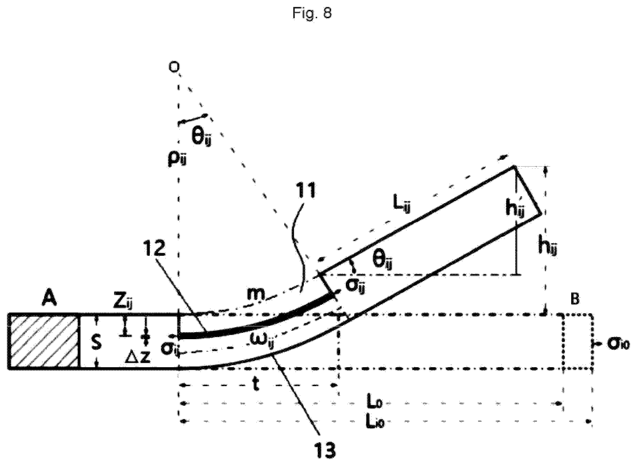

Specifically, as shown in FIGS. 2 and 8, an x-direction is defined as a length direction of the thin plate and a residual stress measurement direction, a y-direction is a width direction of the thin plate, and a z-direction is a thickness direction of the thin plate. The thin plate is initially in a static balance state, and resultant force of x-direction residual stress of the thin plate is zero in the width direction (y direction) of the thin plate. In the embodiment, i=1, 2, 3, . . . , 10, and specific operation processes of S1.1 and S1.2 are as follows: 11 cutting marks that extend in the length direction (x direction) of the thin plate are arranged at intervals in the width direction (y direction) of the thin plate, the plurality of cutting marks are parallel to each other and have the same length, one end of each cutting mark extends to one end of the thin plate in the length direction (x direction) of the thin plate, and the other end is located on a plane of the thin plate. A region between any two cutting marks forms one fin, and there are 10 fins in total, which are fin 1, fin 2, fin 3, fin 4, . . . , fins 10 in the width direction (y direction) of the thin plate. The length L₀ of the cutting mark is recorded, and serves as initial lengths of the 10 fins not cut. Each cutting mark is sequentially cut through the thin plate through a linear cutting method, a cutting direction is parallel to the thickness direction (z direction) of the thin plate, and 10 fins (fin 1 to fin 10, that is, 1, 2, 3, . . . , i in figures) are obtained. After cutting, each of the 10 fins is of a strip-shaped structure with one end fixed and the other end movable. After all the above fins are obtained through the linear cutting method, the resultant force of the residual stress borne by the fins in the thickness direction (z direction) of the thin plate is released, the 10 fins deform under the influence of the x-direction residual stress in the thin plate, and a length Lᵢ₀ of each fin after deformation is recorded. L₀ is less than the length of the thin plate, deformation of the fin includes elongation or shortening of the fin in the length direction of the thin plate, and Lᵢ₀ is an overall length of the ith fin after deformation, for example, L₁₀ is a length of the fin 1 after deformation. In the embodiment, lengths of each fin before and after cutting are generally measured by a laser displacement sensor. Specifically, before the cutting marks are cut, initial position coordinates (that is, coordinates of positions P₁, P₂, P₃ . . . , Pᵢ in FIG. 3) of an end of the fin located on a side of an end of the thin plate are measured by the laser displacement sensor. After the cutting marks are cut, deformation position coordinates (that is, coordinates of positions P₁′, P₂′, P₃′ . . . , Pᵢ′ in FIG. 4) of the movable end (which is the same end as the end of the above fin) of the fin after deformation are measured by the laser displacement sensor. According to coordinates of Pᵢ′ and Pᵢ, a deformation length of each fin in the length direction (x direction) of the thin plate may be obtained, and an overall length Lᵢ₀ of each fin after deformation in the length direction (x direction) of the thin plate may be obtained.

In some embodiments, S1 further includes: S1.3: compute the x-direction strain εᵢ₀ and the x-direction residual stress σᵢ₀, εᵢ₀=(L₀−Lᵢ₀)/L₀ and σᵢ₀−Eεᵢ₀, in the length direction of the thin plate borne by the each fin according to the recorded initial length L₀ of the fin and the deformation length Lᵢ₀ of the fin, where E is an elastic modulus of the thin plate. As shown in FIG. 8, in the embodiment, x-direction strain εᵢ₀, εᵢ₀=(L₀−Lᵢ₀)/L₀, of each fin is computed according to the obtained Lᵢ₀ of each fin after deformation and initial lengths L₀ of all fins before cutting. With fin 1 as an example, ε₁₀=(L₀−L₁₀)/L₀, and εᵢ₀ of other fins are similar. According to the obtained ε₁₀, ε₂₀, ε₃₀ . . . , ε₁₀₀, a distribution difference of residual stress in the width direction (y direction) of the thin plate is obtained.

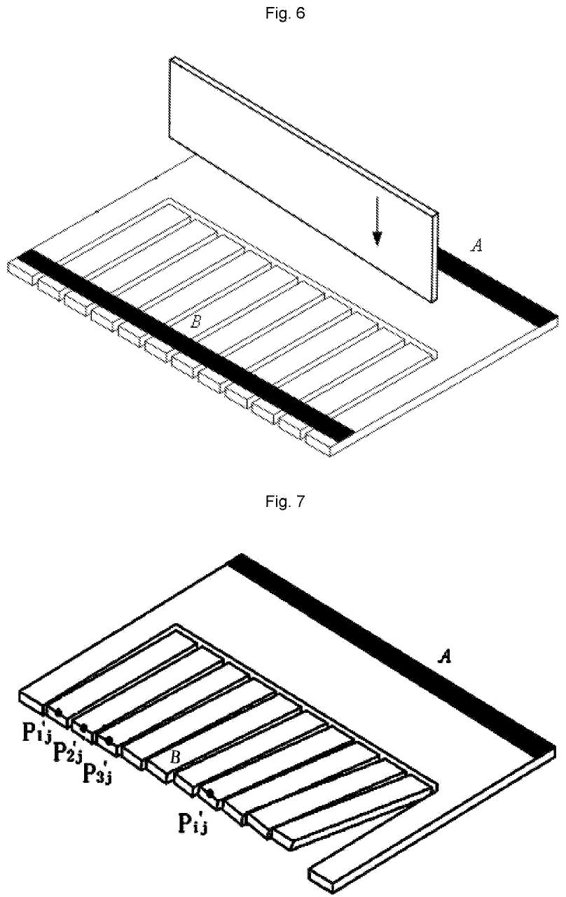

As shown in FIGS. 5-8, S2 includes: constrain two ends of the thin plate in the length direction before each cutting, so as to make an extension direction of each fin parallel to the width direction of the thin plate, and release the constraint on the thin plate on one side of the movable end of the fin after each cutting, so as to compute and record the bending parameter of the ith fin after jth cutting. In the embodiment, end A and end B of the thin plate after the step S1 are fixed, so as to ensure that an initial state of each fin is the same as each other. End B is released after each cutting, so as to break balance of the residual stress in the thickness direction (z direction) of the thin plate, such that a different degree of warping deformation occurs on each fin. Bending conditions of the 10 fins in the same initial state in the case of the same cutting depth are observed, and a bending parameter of each fin after each cutting is recorded.

As shown in FIG. 8, the total cutting depth Zᵢⱼ and the x-direction residual stress σᵢⱼ of each fin after each cutting is expressed as:

$$S > {Z}_{ij} = j Δ z ; {L}_{ij} = {L}_{i 0} - t$$

$$and {σ}_{ij} = \frac{E π}{90 m \cdot Δ z \cdot [ S - ( j - 1 ) ] Δ z} ( {I}_{ij} arcsin \frac{{h}_{ij}^{′}}{{L}_{ij}} - {I}_{i ( j - 1 )} arcsin \frac{{h}_{i ( j - 1 )}^{′}}{{L}_{ij}} ) ;$$

where Δz is a cutting depth of each cutting, t is a cutting width, Iᵢⱼ is an inertia moment of an uncut portion of the ith fin after jth cutting, E is a Young's elastic modulus of the thin plate, hᵢⱼ′ is a warpage quantity of the ith fin after jth cutting minus a warpage quantity of a cut portion, hᵢⱼ is a bending height of the ith fin after jth cutting, Lᵢⱼ is a remaining length of the ith fin after jth cutting, S is a thickness of the thin plate, m is an equivalent arc length of residual stress release of the ith fin after jth cutting, and under the condition that t is infinitely close to 0, a computational formula for σᵢⱼ is expressed as

$${σ}_{ii} = \frac{E π}{90 m \cdot Δ z \cdot [ S - ( j - 1 ) ] Δ z} ( {I}_{ij} arcsin \frac{{h}_{ij}}{{L}_{ij}} - {I}_{i ( j - 1 )} arcsin \frac{{h}_{i ( j - 1 )}}{{L}_{i ( j - 1 )}} ) .$$

In the embodiment, cutting is carried out through an electric spark electrode discharge cutting method, a cutting direction is perpendicular to a surface of the thin plate, and ends of the fixed ends of all fins are simultaneously cut. In the cases of Lᵢⱼ and the number of times of cutting j=0, Lᵢⱼ=Lᵢ₀. Since a cutting width t of any fin does not change, a plurality of Lᵢⱼ of an ith fin are the same as each other. For example, L₁₁ of a first fin (fin 1) after first cutting is the same as L₁₂ of the first fin (fin 1) after second cutting. In the cases of hᵢⱼ and j=0, hᵢ₀=hᵢⱼ. Since a total cutting depth Zᵢⱼ of any fin progressively increases, a plurality of hᵢⱼ of the ith fin are different from each other. For example, h₁₁ of the first fin (fin 1) after first cutting is different from h₁₂ of the first fin (fin 1) after second cutting, and hᵢⱼ′ is similar.

With fin 1 after two-time cutting as an example, a total cutting depth after second cutting is Z₁₂=2Δz, and residual stress of fin 1 after second cutting is

$${σ}_{12} - \frac{E π}{90 m \cdot Δ z \cdot [ S - ( 2 - 1 ) ] Δ z} ( {I}_{12} arcsin \frac{{h}_{12}^{′}}{{L}_{12}} - {I}_{11} arcsin \frac{{h}_{11}^{′}}{{L}_{11}} ) .$$

Therefore, the residual stress of each fin after each cutting may be computed, and distribution of x-direction residual stress in the thickness direction of the thin plate borne by each fin may be obtained according to all the obtained σᵢⱼ. Under the condition that t is infinitely close to 0, residual stress release is small, a bending degree is low, #^{h}^{ᵢⱼ} approximately equals to hᵢⱼ′, and thus

$${σ}_{12} = \frac{E π}{90 m \cdot Δ z \cdot [ S - ( 2 - 1 ) ] Δ z} ( {I}_{12} arcsin \frac{{h}_{12}^{′}}{{L}_{12}} - {I}_{11} arcsin \frac{{h}_{11}}{{L}_{11}} ) .$$

Specifically, j in the embodiment is an integer greater than 0.

In some embodiments, m is approximately expressed as: m=t+0.75S; alter jth cutting of the ith fin, a notch 11 is formed, and the ith fin is bent to form a first bent surface 12 and a second bent surface 13 that are spaced apart from each other in the thickness direction of the thin plate; on an xz cross section of the thin plate, the first bent surface 12 and the second bent surface 13 are two arcs that have the same curvature but different arc lengths, the equivalent arc length m is a length of an arc formed between two ends of an opening of the notch 11 on the cross section, and curvature of the equivalent arc length m is the same as curvature of the two arcs; and hᵢⱼ′ is a height between a warping end of the opening of the notch 11 on the cross section and a top end of the fin ater warping, and hᵢⱼ is a height between a non-warping end of the opening of the notch 11 on the cross section and the top end of the fin after warping.

In the embodiment, hᵢⱼ may be also obtained by a laser displacement sensor. Specifically, coordinates of positions P₁′, P₂′, P₃′ . . . , Pᵢ′ in FIG. 4 serve as the standard, and the movable ends of all the fins are re-measured after each cutting. With one-time cutting as an example (that is, in the case of j=1), coordinates of positions P₁₁′, P₂₁′, P₃₁′ . . . , Pᵢ₁′ are obtained. Similarly, in the case of two-time cutting (j=2), coordinates of positions P₁₂′, P₂₂′, P₃₂′ . . . , Pᵢ₂′ are obtained. By comparing coordinates of Pᵢ′ and Pᵢⱼ′ before and after cutting, hᵢⱼ and other relevant parameters may be obtained. Alternatively, hᵢⱼ′ may be obtained by a laser displacement sensor, and a measurement method is the same as that for hᵢⱼ.

In the embodiment, the σᵢⱼ is obtained according to formulas as follows:

$$d ( \sum {M}_{ij} ) = {σ}_{ij} \cdot Δ z \cdot m \frac{[ S - ( j - 1 ) Δ z ]}{2} ;$$

$$and d ( \sum {M}_{ij} ) = \frac{E π}{180} ( {I}_{ij} arcsin \frac{{h}_{ij}^{′}}{{L}_{ij}} - {I}_{i ( j - 1 )} arcsin \frac{{h}_{i ( j - 1 )}^{′}}{{L}_{ij}} ) ;$$

where ΣMᵢⱼ is a total bending moment of the ith fin after jth cutting, and d(ΣMᵢⱼ) is a bending moment increment of the ith fin after jth cutting. d(ΣMᵢⱼ)=ΣMᵢⱼ−ΣMᵢ₍ⱼ₋₁₎.

Specifically, a computational method for ΣMᵢⱼ is as follows: ΣMᵢⱼ=ωᵢⱼMᵢⱼ; wherein ωᵢⱼ_{_{#}} an average arc length, and Mᵢⱼ_{_{#}} an average bending moment of the residual stress of the ith fin after jth cutting on an arc length of any unit; and after j-th cutting, the i-th fin is bent to form a first bent surface 12 and a second bent surface 13 that are spaced apart from each other in the thickness direction of the thin plate, on an xz cross section of the thin plate, the first bent surface 12 and the second bent surface 13 are two arcs that have the same curvature but different arc lengths, the average arc length is between the two arcs, curvature of the average arc length is the same as curvature of the two arcs, and distances between the average arc length and the arcs on two sides are the same.

Wherein, a computational method for Mᵢⱼ is as follows

$$\# {M}_{ij} = \frac{{EI}_{ij} π}{180 {ω}_{ij}} arcsin \frac{{h}_{ij}^{′}}{{L}_{ij}} .$$

With fin 1 after two-time cutting as an example M₁₂_{_{#}} as follows:

$${M}_{12} = \frac{{EI}_{12} π}{180 {ω}_{12}} arcsin \frac{{h}_{12}^{′}}{{L}_{12}} .$$

According to ΣMᵢⱼ=ωᵢⱼMᵢⱼ, it can be inferred that

$$\sum {M}_{ij} = \frac{E {I}_{ij} π}{180} arcsin \frac{{h}_{ij}^{′}}{{L}_{ij}} .$$

With fin 1 after two-time cutting as an example, ΣMᵢⱼ is as follows:

$$\sum {M}_{12} = \frac{E {I}_{12} π}{180} arcsin \frac{{h}_{12}^{′}}{{L}_{12}} .$$

Further, a computational method for ωᵢⱼ is as follows:

$$\# {θ}_{ij} = \frac{{ω}_{ij}}{{ρ}_{ij}} \cdot \frac{180}{π} ;$$

wherein ρᵢⱼ is a curvature radius of the ith fin after jth cutting, and θᵢⱼ is a bending angle of the ith fin after jth cutting.

In the embodiment, with fin 1 after two-time cutting as an example,

$${θ}_{12} = \frac{{ω}_{12}}{{ρ}_{12}} \cdot \frac{180}{π} .$$

Alternatively, ρᵢⱼ may be also obtained by a laser displacement sensor, and a measurement method is the same as that for hᵢⱼ.

A computational method for θᵢⱼ is as follows:

$${θ}_{ij} = arcsin \frac{{h}_{ij}^{′}}{{L}_{ij}} .$$

With fin 1 after two-time cutting as an example,

$${θ}_{12} = arcsin \frac{{h}_{12}^{′}}{{L}_{12}} .$$

Further, a computational method for Iᵢⱼ is as follows:

$$\frac{1}{{ρ}_{ij}} = \frac{{M}_{ij}}{{EI}_{ij}} ;$$

wherein ρᵢⱼ is a curvature radius of the ith fin after jth cutting, and Mᵢⱼ is a bending moment of the ith fin after jth cutting. With fin 1 after two-time cutting as an example,

$$\frac{1}{{ρ}_{12}} = \frac{{M}_{12}}{{EI}_{12}} .$$

In the embodiment, S2 further includes: correct the residual stress;

$$Δ ( {σ}_{ij} ) = \frac{{σ}_{ij} \cdot Δ z}{S - j Δ z} ; and {σ}_{ij}^{′} = {σ}_{ij} - {\sum }_{1}^{j - 1} Δ {σ}_{ij} ;$$

wherein Δ(σᵢⱼ) is an effect of residual stress of layer Δz on residual stress of the uncut portion, and σᵢⱼ′ is a residual stress correction value of the ith fin during jth cutting. Through such arrangement, distribution reliability of residual stress σᵢⱼ on the thin plate and characterization accuracy are ensured.

What are described above are merely some embodiments of the disclosure and are not intended to limit the disclosure, and for those skilled in the art, the disclosure can be variously modified and changed. Any modification, equivalent substitution, improvement, etc. within the spirit and principles of the disclosure shall fall within the scope of protection of the disclosure.

What is claimed is:

1. A method for measuring residual stress in a thin plate, comprising:
S1: prearranging and cutting a plurality of fins that are parallel to a length direction of the thin plate at equal intervals along a width direction of the thin plate, wherein a length of each fin is the same as each other and less than a width of the thin plate, and the each fin has a fixed end and a movable end that are opposite each other, computing x-direction strain εᵢ₀ and x-direction residual stress σᵢ₀ in the length direction of the thin plate borne by the each fin according to lengths of the each fin before and after cutting, and obtaining distribution of x-direction residual stress in the width direction of the thin plate according to σᵢ₀ of all the fins;
S2: repeatedly cutting the fixed end of the each fin in a thickness direction of the thin plate, recording a cutting parameter, and a warpage condition and a bending parameter of the each fin after each cutting, computing a total cutting depth Zᵢⱼ and x-direction residual stress σᵢⱼ of the each fin after each cutting, and obtaining distribution of x-direction residual stress in the thickness direction of the thin plate borne by an ith fin according to all σᵢⱼ; and
S3: computing distribution σₓ, σₓ=σᵢ₀+σᵢⱼ, of x-direction residual stress on a yz cross section of the thin plate according to σᵢ₀ of the ith fin computed in S1 and corresponding σᵢⱼ of the ith fin after jth cutting in S2.

2. The method for measuring residual stress in the thin plate according to claim 1, wherein S1 comprises:
S1.1: arranging cutting marks at equal intervals in the width direction of the thin plate, wherein an extension direction of each cutting mark is the same as each other and parallel to the length direction of the thin plate and extends to an end of the thin plate, an extension length of the each cutting mark is less than a length of the thin plate, and a region between any two cutting marks forms one fin, and recording an initial length L₀ of the ith fin before cutting; and
S1.2: cutting the cutting marks through the thin plate in a thickness direction of the thin plate, and recording a deformation length Lᵢ₀ of the each fin after deformation in the length direction of the thin plate.

3. The method for measuring residual stress in the thin plate according to claim 2, wherein S1 further comprises:
S1.3: computing the x-direction strain εᵢ₀ and the x-direction residual stress σᵢ₀, εᵢ₀=(L₀−Lᵢ₀)/L₀ and σᵢ₀=Eεᵢ₀, in the length direction of the thin plate borne by the each fin according to the recorded initial length L₀ of the each fin and the deformation length Lᵢ₀ of the fin, wherein E is an elastic modulus of the thin plate.

4. The method for measuring residual stress in the thin plate according to claim 1, wherein S2 comprises:
constraining two ends of the thin plate in the length direction before each cutting, so as to make an extension direction of the each fin parallel to the width direction of the thin plate, and releasing the thin plate on a side of the movable end of the each fin after each cutting, so as to compute and record the bending parameter of the ith fin after jth cutting.

5. The method for measuring residual stress in the thin plate according to claim 4, wherein the total cutting depth Zᵢⱼ and the x-direction residual stress σᵢⱼ of the each fin after each cutting are expressed as:
$$S > {Z}_{ij} = j Δ z ;$$
$${L}_{ij} = {L}_{i 0} - t ; and$$
$${σ}_{ij} = \frac{E π}{90 m \cdot Δ z \cdot [ S - ( j - 1 ) ] Δ z} ( {I}_{ij} arc sin \frac{{h}_{ij}^{′}}{{L}_{ij}} - {I}_{i ( j - 1 )} arc sin \frac{{h}_{i ( j - 1 )}^{′}}{{L}_{ij}} ) ;$$
wherein
Δz is a cutting depth of each cutting, t is a cutting width, Iᵢⱼ is inertia moment of an uncut portion of the ith fin after jth cutting, E is a Young's elastic modulus of the thin plate, hᵢⱼ_{_{#}}′ a warpage quantity of the ith fin after jth cutting minus a warpage quantity of a cut portion, hᵢⱼ is a bending height of the ith fin after jth cutting, Lᵢⱼ is a remaining length of the ith fin after jth cutting, S is a thickness of the thin plate, m is an equivalent arc length of residual stress release of the ith fin after jth cutting, and
under a condition that t is infinitely close to 0, a computational formula for σᵢⱼ is expressed as:
$${σ}_{ij} = \frac{E π}{90 m \cdot Δ z \cdot [ S - ( j - 1 ) ] Δ z} ( {I}_{ij} arc sin \frac{{h}_{ij}}{{L}_{ij}} - {I}_{i ( j - 1 )} arc sin \frac{{h}_{i ( j - 1 )}}{{L}_{i ( j - 1 )}} ) .$$

6. The method for measuring residual stress in the thin plate according to claim 5, wherein m is approximately expressed as: #^{m=t+0.75S}; after jth cutting of the ith fin, a notch is formed, and the ith fin is bent to form a first bent surface and a second bent surface that are spaced apart from each other in the thickness direction of the thin plate; on an xz cross section of the thin plate, the first bent surface and the second bent surface are two arcs that have the same curvature but different arc lengths, the equivalent arc length m is a length of an arc formed between two ends of an opening of the notch on the cross section, and curvature of the equivalent arc length m is the same as curvature of the two arcs; and hᵢⱼ′ is a height between a warping end of the opening of the notch on the cross section and a top end of a corresponding fin after warping, and hᵢⱼ is a height between a non-warping end of the opening of the notch on the cross section and the top end of the fin after warping.

7. The method for measuring residual stress in the thin plate according to claim 5, wherein σᵢⱼ is obtained according to formulas as follows:
$$d ( \sum {M}_{ij} ) = {σ}_{ij} \cdot Δ z \cdot m \frac{[ S - ( j - 1 ) Δ z ]}{2} ; and$$
$$d ( \sum {M}_{ij} ) = \frac{E π}{180} ( {I}_{ij} arc sin \frac{{h}_{ij}^{′}}{{L}_{ij}} - {I}_{i ( j - 1 )} arcsin \frac{{h}_{i ( j - 1 )}^{′}}{{L}_{ij}} ) ;$$
wherein
ΣMᵢⱼ is a total bending moment of the ith fin after jth cutting, and d(ΣMᵢⱼ) is a bending moment increment of the ith fin after jth cutting.

8. The method for measuring residual stress in the thin plate according to claim 7, wherein a computational method for ΣMᵢⱼ is as follows:
$$\sum {M}_{ij} = {ω}_{ij} {M}_{ij} ;$$
wherein
ωᵢⱼ is an average arc length, and Mᵢⱼ is average bending moment of residual stress of the ith fin after jth cutting on an arc length of any unit; and after jth cutting, the i-th fin is bent to form a first bent surface and a second bent surface that are spaced apart from each other in the thickness direction of the thin plate, on an xz cross section of the thin plate, the first bent surface and the second bent surface are two arcs that have the same curvature but different arc lengths, the average arc length is between the two arcs, curvature of the average arc length is the same as curvature of the two arcs, and distances between the average arc length and the arcs on two sides are the same.

9. The method for measuring residual stress in the thin plate according to claim 8, wherein a computational method for Mᵢⱼ is as follows:
$${M}_{ij} = \frac{{EI}_{ij} π}{180 {ω}_{ij}} arc sin \frac{{h}_{ij}^{′}}{{L}_{ij}} .$$

10. The method for measuring residual stress in the thin plate according to claim 9, wherein computational methods for ωᵢⱼ, θᵢⱼ and Iᵢⱼ are as follows:
$${θ}_{ij} = \frac{{ω}_{ij}}{{ρ}_{ij}} \cdot \frac{180}{π} ;$$
$${θ}_{ij} = arcsin \frac{{h}_{ij}^{′}}{{L}_{ij}} ; and$$
$$\frac{1}{{ρ}_{ij}} = \frac{{M}_{ij}}{{EI}_{ij}} ;$$
wherein
ρᵢⱼ is a curvature radius of the ith fin after jth cutting, and θᵢⱼ is a bending angle of the ith fin after jth cutting.

11. The method for measuring residual stress in the thin plate according to claim 10, wherein S2 further comprises: correcting the residual stress;
$$Δ ( {σ}_{ij} ) = \frac{{σ}_{ij} \cdot Δ z}{S - j Δ z} ; and$$
$${σ}_{ij}^{′} = {σ}_{ij} - {\sum }_{1}^{j - 1} Δ {σ}_{ij} ;$$
wherein Δ(σᵢⱼ) is an effect of residual stress of layer Δz on residual stress of the uncut portion, and σᵢⱼ′ is a residual stress correction value of the ith fin during jth cutting.
